(19) United States
(12) Patent Application Publication
(10) Pub. No.: US 2008/0298352 A1
(43) Pub. Date: Dec. 4, 2008

(54) Method for portable fixed line

(75) Inventor: Chen-Jen Yang, Hsinchu (TW)

Correspondence Address: BIRCH STEWART KOLASCH & BIRCH, PO BOX 747, FALLS CHURCH, VA, 22040-0747, US

(73) Assignee: BROWAN COMMUNICATIONS, Inc.

(21) Appl. No.: 11/806,631

(22) Filed: Jun. 1, 2007

(51) Int. Cl. H04L 12/66

(52) U.S. Cl. 370/356

(57) ABSTRACT

The present invention provides a method to make a fixed line of telephone network virtually portable, particularly to a method of expansion of a plain old telephone service, to be able to provide new communication service via Internet for a subscriber by integrating phone adapter with software phone terminal, comprising: firstly, a call request with ringing signal is sent from PSTN; and then receiving the call request by an adapter; re-sending the call request with ringing signal to a telephone connected to adapter, and concurrently resending the call request to a center management system via Internet and then to a software phone; next, receiving the response with answer signal by the adapter from either the telephone or the software phone; and finally, communicating between a remote terminal of PSTN and response terminal.

### FIELD OF INVENTION

The present invention relates to make a fixed line of telephone network virtually portable, particularly to a method of expansion of a plain old telephone service, to be able to provide new communication service via Internet for a subscriber by integrating phone adapter with software phone terminal.

### BACKGROUND OF INVENTION

Communication systems for transmitting telephone calls have become an integral, indispensable part of everyday life. The first roots of telephony were planted in 1876 with the invention of the first practical telephone by Alexander Graham Bell. As the number of calling stations or customer lines (telephones) in the system began to grow, the wiring system interconnecting the telephones became extremely complicated and unwieldy. Each customer line terminated in a local switching system commonly referred to as a central office. The central office then performed the task of connecting each of the telephone lines it served to a corresponding telephone line in order to complete a call. If the two parties to a call were serviced by the same central office, then the connection could be completed by the same central office without having to resort to other portions of the telecommunications network. If the call required connection to a telephone line serviced by a distant central office, then a connection between the central offices was carried out using a trunk, i.e., a connection between two central offices.

The invention of telephone promotes the speed and efficiency of communication; universal utility of the telephone shrinks communication gap between nationals or regions via telephone. However, operation of the telephone system includes telephone signals go through to a control room or a central office via a fixed line for switching signals, and followed by transmitting the signals via the fixed line, and each of the fixed line with its own predetermined number for identifying. Therefore, a user who dials or answers a phone call must reply on the fixed line to communicating with others.

As above mention, a mobile phone can resolve the issue for a user employing the fixed line for communicating with others. A mobile phone system allows for a user dialing or hearing a ringing call freely motions, anywhere without through the fixed line. However, user has to suffer high communication fee of the mobile phone. The longer talking time user takes, the higher fee user has to pay. Especially in transnational roaming mobile communication, user possesses benefit of convenient communication but should pay highly communication cost.

We all know that the voice technology via Internet is well developed nowadays; it has fulfilled as good voice quality as fixed line can offer and in-network call is almost free, and thereby making VoIP (Voice over IP) to be popularly used. Although VoIP provides a high benefit to user, but different VoIP systems can not connect and communicate with each other due to lack of standard specification among the VoIP systems, and thereby limiting the VoIP communication usage.

As above-mentioned, current telephone system has three drawbacks including 1. high communication fee; 2. too many phone numbers to use, for example home telephone, mobile phone, office telephone, Internet phone etc.; 3. the lack of standards for interoperability over different platforms. Therefore, the present invention provides a method and system which allow for a user available freely motion dialing, low communication fee and utilizing one phone number scheme for resolving the above-mentioned issue.

### SUMMARY OF THE INVENTION

The present invention is a dual way process, to be able to provide communication service via Internet to fixed line.

The present invention provides a method of expansion of a plain old telephone service, to be able to provide communication service via Internet, comprising three approaches as follows:

### 1. From Fixed Line to Software Phone

Firstly, a ringing signal is sent from PSTN via fixed line; and then receiving the ringing signal by an adapter; secondly, the adapter re-sending the ringing signal for the call request to two devices: to the telephone connected to the adapter, and to a center management system via Internet and then sending the call request to a software phone from the center management system; third, receiving a response with answer signal by the adapter from either the telephone or the software phone; fourth, the adapter transferring the call to the response terminal; and finally, communicating between a remote terminal of PSTN and the response terminal via Internet.

The step of re-sending a ringing signal to both of a telephone connected to the adapter and to a remote software phone via Internet is achieved synchronously. Wherein receiving the answer signal by the adapter from either the telephone or the software phone, and then the other will stop the ringing signal.

The software phone may be embedded in a portable device, and wherein the portable device comprises a personal computer, notebook (NB), personal digital assistant (PDA) or mobile phone.

### 2. From Software Phone to Specific Fixed Line

Second approach of the present invention is provided a method of expansion of a plain old telephone service, to be able to provide communication service via Internet, comprising: firstly, a call request is sent from software phone by clicking either one of contacts from contact list or a function button, and then sending the call request to a center management system via Internet; secondly, transmitting the call request by the center management system to an adapter; judging the call request by the adapter whether sending the ringing signal to a telephone connected to the adapter, or feedback the dialing signal of fixed line from PSTN to software phone; third, then sending a callee phone number from software phone to the adapter; fourth, transmitting the callee phone number to PSTN; and finally, communicating between the software phone and the telephone or the callee phone.

The step of whether sending the ringing signal to a telephone, or feedback the dialing signal from PSTN to software phone is judged by the adapter. While judging the call request by clicking a function button of software phone, feedback the dialing signal from PSTN to software phone. While judging the call request by clicking one of contacts from contact list of software phone, sending the ringing signal to the telephone connected to adapter.

The step of sending a call request from a software phone comprises the user utilizes the software phone to select a callee from a common contact lists or a function button. The step of dialing a callee phone number is executed after the user hearing the dialing signal from PSTN via Internet, transmitting by the adapter.

### 3. From Software Phone to Selectable Fixed Line

Third approach of the present invention is provided a method of expansion of a plain old telephone service, to be able to provide communication service via Internet, comprising: firstly, selecting a predetermined adapter of built-in white lists and sending a call request from a software phone; and then sending the call request to a center management system via Internet; secondly, transmitting the call request by the center management system to the predetermined adapter; third, checking usufruct of the call request with built-in white lists by the predetermined adapter and feedback the dialing signal from PSTN; forth, dialing a callee phone number by software phone; next, transmitting said callee phone number to said PSTN by the adapter; and finally, communicating between the software phone and the callee phone.

The step of sending a call request from a software phone comprises the user utilizes the software phone to select the predetermined adapter from a list. The adapter has white list built-in and authenticating the call request automatically. The step of dialing a callee phone number is executed after the user of software phone hearing the dialing signal from PSTN.

### BRIEF DESCRIPTION OF THE DRAWING

For a better understanding of the present invention and to show how it may be implemented, reference will now be made to the following drawings:

FIG. 1 is a block diagram showing the system of portable fixed line network of the present invention for the first and second approach.

FIG. 2 is a block diagram showing the system of portable fixed line network of the present invention for the third approach.

FIG. 3 is a block diagram showing the phone adapter of the present invention.

FIG. 4 is a block diagram showing the portable device with software phone installed of the present invention.

FIG. 5 is a flow chart showing the method of portable fixed line network of the present invention for the first approach.

FIG. 6 is a flow chart showing the method of portable fixed line network of the present invention for the second approach.

FIG. 7 is a flow chart showing the method of portable fixed line network of the present invention for the third approach.

### DESCRIPTION OF THE PREFERRED EMBODIMENT

The present invention is described with the preferred embodiments and accompanying drawings. It should be appreciated that all the embodiments are merely used for illustration. Hence, the present invention can also be applied to various embodiments other than the preferred embodiments.

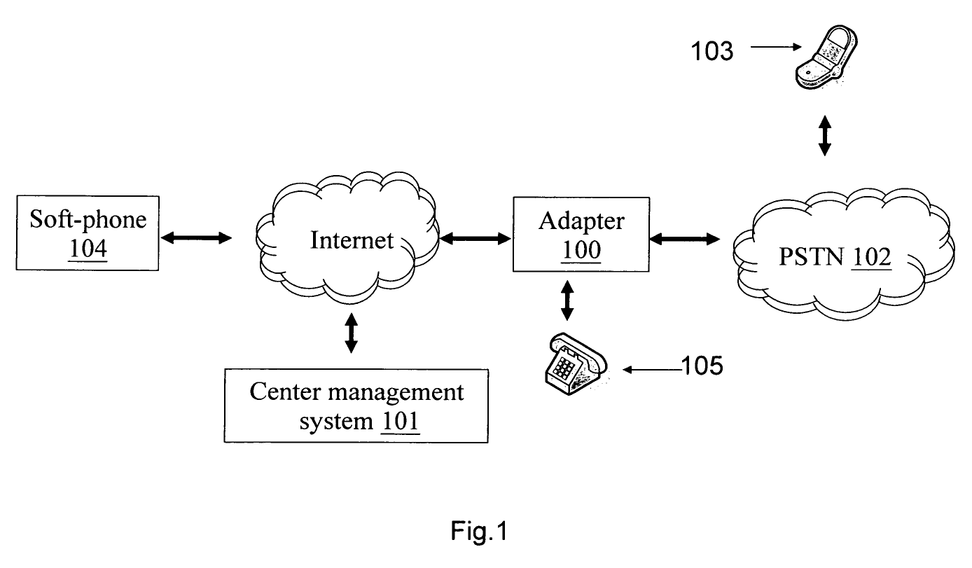

In FIG. 1, the present invention provides a portable fixed line. The present invention is to make a fixed line of telephone network virtually portable, particularly to a method of expansion of a plain old telephone service, to be able to provide new communication service via Internet for a subscriber by integrating phone adapter with remote software phone terminal. In one case, the remote software phone terminal may comprise personal computer, notebook (NB), personal digital assistant (PDA) or mobile phone with software phone installed.

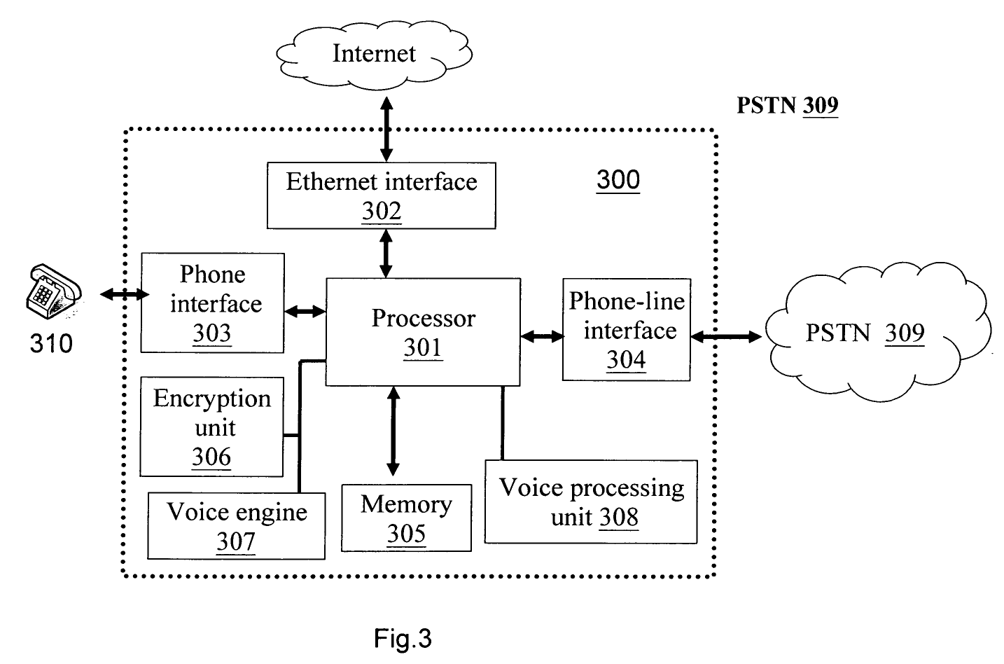

Referring to FIG. 1, it illustrates a block diagram showing the system of portable fixed network of the present invention with Internet phone capability. The diagram is used for illustrating and not used for limiting the scope of the present invention. The invention is to make communication without the limitation of fixed line, connecting PSTN and Internet by using adapter and software phone. The whole system includes a phone 103, a PSTN 102, a phone adapter 100, a telephone 105, the Internet, a center management system 101 and software phone 104. As known, the phone 103 connects to PSTN 102. The public switched telephone network (PSTN) is the network of the world's public circuit-switched telephone networks, in much the same way that the Internet is the network of the world's public IP-based packet-switched networks. In the present invention, the phone adapter 100 includes three ports to connect the PSTN 102, the telephone 105 and the Internet, respectively. Referring to FIG. 3, it illustrates a block diagram showing the phone adapter of the present invention. The phone adapter 300 may act as an agent gateway. The phone adapter 300 includes three interfaces including an Ethernet (Internet) interface 302, a phone interface 303 and a phone-line interface 304 to connect the Internet, PSTN 309 and a telephone 310, respectively. The Ethernet (Internet) interface 302, the phone interface 303 and the phone-line interface 304 are coupled to a processor 301. The phone adapter 300 further includes a processor 301 for example MCU (eg. produced by ARM, Micron), a voice engine 307, a voice processing unit 308, an encryption unit 306 and memory 305. The phone adapter 300 has the processor 301 to process data or signal, thereby transforming the analog telephone signal into digital, packetized format and vice versa. The voice engine 307 may be speech recognition software. The voice processing unit 308 is used to process voice data. The encryption unit or module 306 is used for encrypting data. The encryption unit 306 may generate a crypto-key according to an identity and encrypts the document into a ciphered document by utilizing the crypto-key, and then the ciphered document is stored in the memory. The memory 305 can be a ROM program memory, a RAM memory or a nonvolatile FLASH memory. All of the units mentioned above are coupled to the processor 301, respectively. The memory could be micro-type hard disc as well.

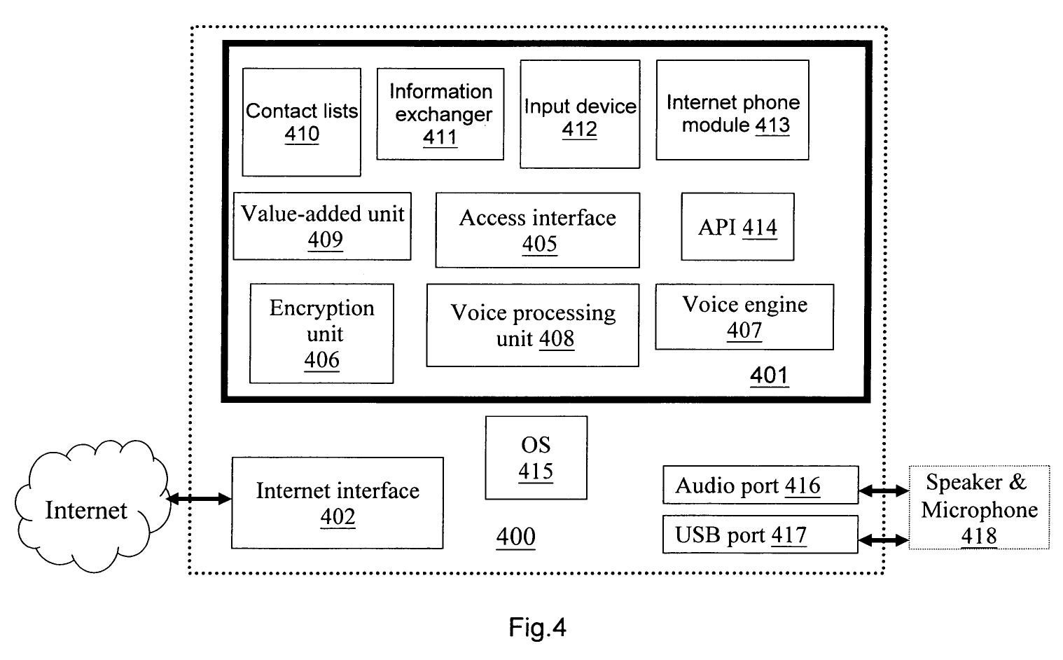

The center management system 101 connects to the Internet. The software phone 104 also connects to the Internet. In general, the center management system 101 comprises: 1. Back-end Database Management which includes management of user profile, billing information, access information, etc., 2. Online Network Management, for example surveillance of network packet flow and online status, etc. The software phone 104 may be embedded in a remote terminal. In one case, the remote terminal may comprise personal computer, notebook (NB), personal digital assistant (PDA) or mobile phone. Referring to FIG. 4, it illustrates a block diagram showing the portable device with software phone installed of the present invention. The portable device 400 comprises a software phone 401, the Internet interface 402, OS 415, audio port 416 and USB port 417. The Internet interface 402 is coupled to the Internet. The audio port 416 and USB port 417 may be coupled to a speaker and microphone 418. The software phone 401 comprises an access interface 405, Internet phone module 413, value-added unit 409, information exchanger 411, input device 412, contact lists 410, a voice engine 407, a voice processing unit 408, an encryption unit 406 and API (Application Interface) 414. All of the units mentioned above are coupled to the processing unit of the portable device 400, respectively. User may use the contact lists 410 to search or select dialing phone number; user may use the value-added unit 409 including“My Phone”function to search or select the phone numbers of the familiar friends or family members. API (Application Interface) 414 which may comprises a telephony API, Win-Socket API, program library, is used for linking to external AP or modifying preference setting of the software phone 401. The access interface 405 of the present invention enables the processor of the portable device 400 to access the telecommunication. The input device 412 is used to input the phone number or IP address of the receiver. Typically, the device 412 includes keypad, writing pad to input the phone number or IP address. The information exchanger 411 may be coupled to the processing unit of the portable device 400 for exchanging information, such as phone number information, application software, updating version of program of the Internet phone module 413.

The Internet phone module 413 may be coupled to the processing unit of the portable device 400 to allow the PSTN telephone transmitting and receiving the audio signal to/from the Internet network. In one embodiment, the Internet phone module 413 comprises FreePP or other software phones with built-in function of present invention.

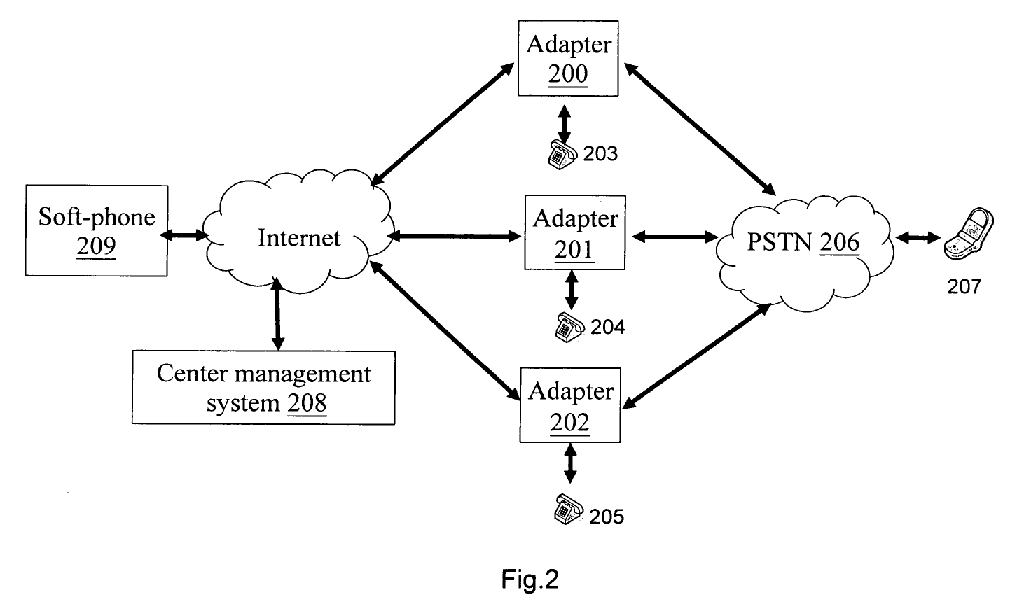

In another embodiment, referring to FIG. 2, it illustrates a block diagram showing the system of portable fixed network with multiple phone adapters of the present invention. The diagram is used for illustrating and not used for limiting the scope of the present invention. The whole system includes a phone 207, a PSTN 206, multiple phone adapters 200, 201, 202, telephones 203, 204, 205, the Internet, a center management system 208 and software phone 209. Similarly, the phone 207 connects to PSTN 206. The phone 206 is for example mobile phone. As above-mentioned, the phone adapters 200, 201, 202 have three ports to connect the PSTN 206, the Internet and the telephone 203, 204, 205, respectively. The phone adapter of the present invention refers to FIG. 3.

The mobile phone of FIG. 1 and 2 may couple to PSTN for linking to the home telephone system and software phone through Internet. The application of the system is quite economical and convenience. Moreover, the user may employ the software phone to synchronously transmit and receive the vocal signal through the Internet by using the Internet phone module of the software phone and the adapter.

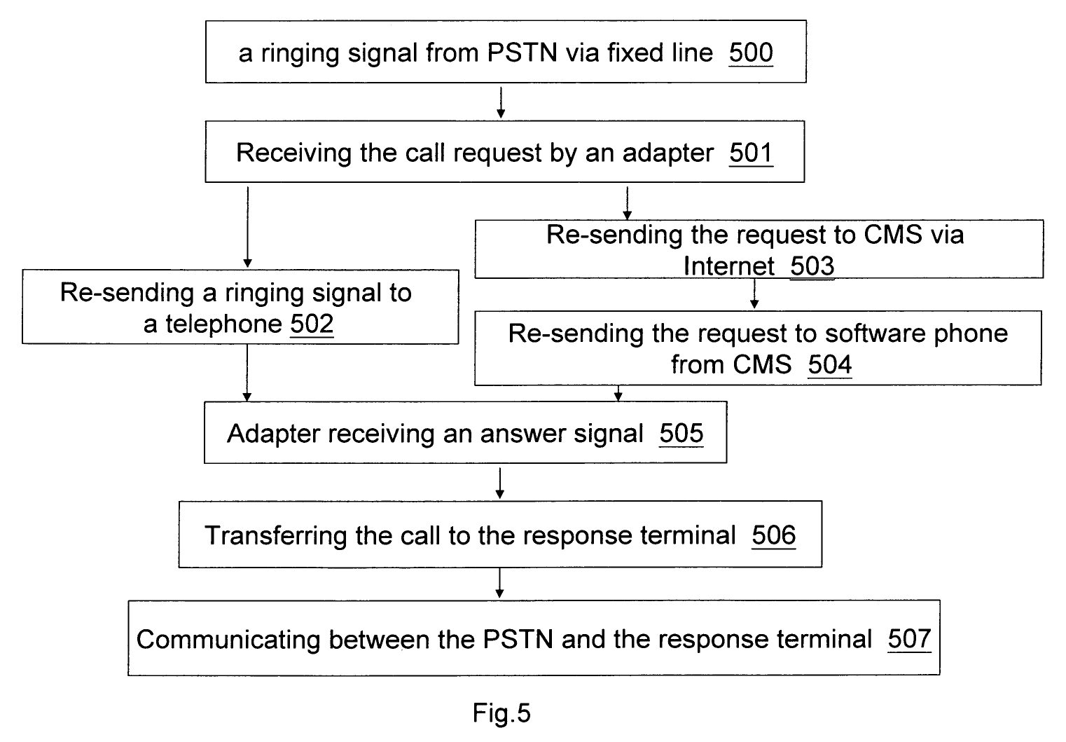

Referring to FIG. 5, it illustrates a flow chart showing the method of portable fixed line of the present invention with Internet phone capability. The flow chart is used for illustrating and not used for limiting the scope of the present invention. The method of portable fixed line network of the present invention may be implemented through the above mentioned system of portable fixed line network. Firstly, in the step 500, someone dials a phone call by a phone to user; a call request is sent by the phone to PSTN and then passing the call request with ringing signal to an adapter via fixed line from the PSTN. The phone is for example mobile phone. Then, in the step 501, the adapter receives and detects the request with ringing signal by the adapter. Subsequently, in the steps 502 and 503, dual modes are achieved; wherein one approach or way is sending a ringing signal for the call request to a telephone connected to adapter, and another approach or way is sending the request to a center management system (CMS) via Internet, and then sending the request to software phone from CMS, in the step 504. Next, in the step 505, the adapter is receiving a response with answer signal from the telephone or the software phone, and then transferring the calling (dialing/ringing signal) to the response terminal which is the telephone or the software phone, in the step 506. Finally, in the step 507, it is completed for communicating between the user and the response terminal.

Therefore, the present invention may utilize the software phone and the adapter for communication between the mobile phone, telephone and the software phone. Next, the user being called can answer the phone call anywhere by software phone, even user is not beside the telephone of fixed line. Further, the communication cost can be reduced by the present invention while user being called goes abroad. The system may achieve dual modes including telephone and software phone via PSTN and Internet, respectively. It will not change the operation custom of the user.

In other words, the user may employ the adapter to connect phone line and telephone. In general, the adapter may allow for user using home telephone calling or dialing to software phone terminal to reduce communication fee. When someone dials a mobile phone to home telephone, the adapter may allow for the home telephone ringing, and then user being called can hook or hang up the telephone to response. Moreover, the adapter may allow a (home) telephone and a software phone terminal ringing synchronously. While one of the telephone and the software phone terminal is selected to answer, the other terminal will stop ringing. In the present invention, phone call may be received by the telephone and the software phone terminal; the telephone of the invention may refer to an extension of a fixed line telephone, expanding the service of plain old telephone system.

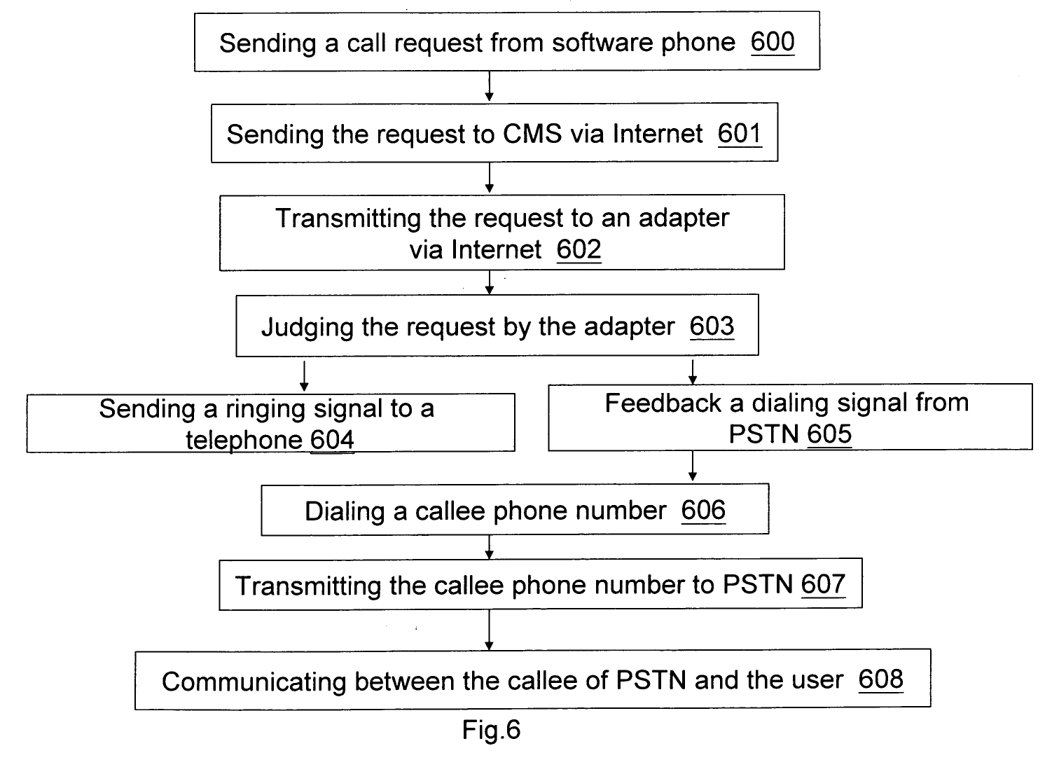

Referring to FIG. 6, it illustrates a flow chart showing the method of portable fixed line network of the present invention, calling from software phone at Internet to fixed line through specific adapter. The flow chart is used for illustrating and not used for limiting the scope of the present invention. In this embodiment, the user terminal is software phone terminal, and which can be also implemented through the above mentioned system of portable fixed line network to achieve communication. Firstly, in the step 600, user dials a phone call from a software phone, in this stage, user utilizes software phone to select a callee from a common contact lists or a value-added unit including“My Phone”function button; sending the call request by the software phone and then passing the request to CMS via Internet in the step 601. Subsequently, in the steps 602, it is transmitting the call request by the CMS to an adapter, and the adapter receives and detects the request; then judging the call request information by the adapter in the step 603. Next, dual modes are achieved; wherein one approach or way is sending a ringing signal to a telephone in the step 604, in one embodiment, user selects a callee from a common contact lists. Another approach or way is sending the call request by the adapter to PSTN, and feedback a dialing signal from PSTN to software phone in the step 605. Next, in the step 606, dialing a callee phone number by the user is executed after user hearing the dialing signal response from PSTN. In the step 607, transmitting the callee phone number by the adapter to PSTN, and then passing the calling message to the callee. Finally, in the step 608, it is completed for communicating between the callee phone, telephone and software phone from software phone via Internet.

Similarly, a value-added unit including“My Phone”function button may be built-in the software phone terminal, while using the function button by the software phone, automatic linking to an adapter from the software phone to fixed line.

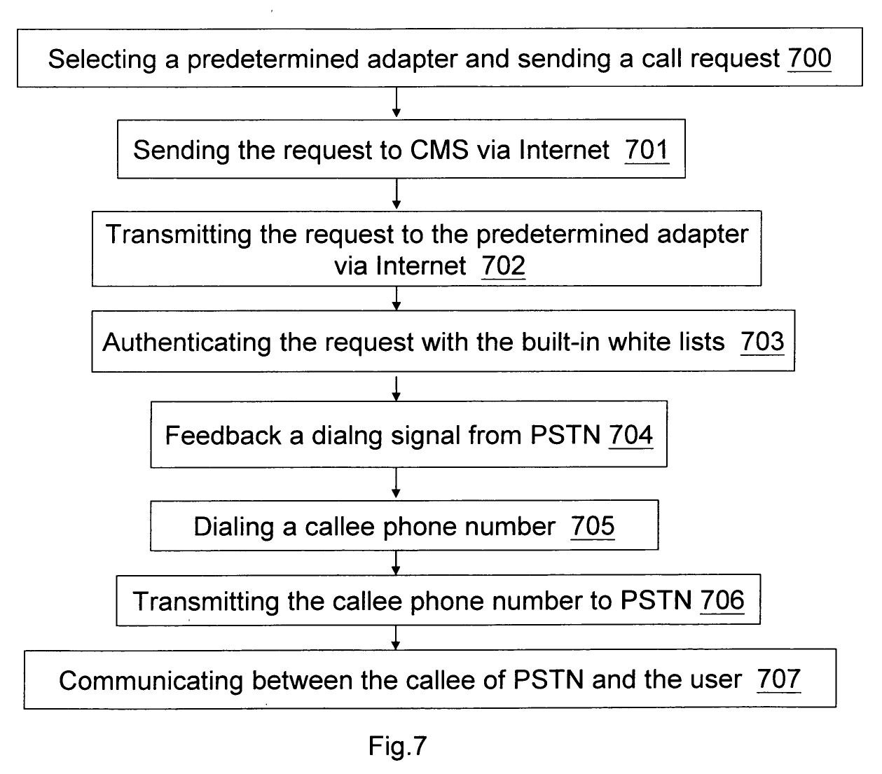

Referring to FIG. 7, it illustrates a flow chart showing the method of portable fixed line network of the present invention, calling from software phone at Internet to fixed line through selectable adapter. The flow chart is used for illustrating and not used for limiting the scope of the present invention. In this embodiment, multiple adapters may be included to be selected. Firstly, in the step 700, user dials a phone call from a software phone, in this stage, user utilizes software phone to select a predetermined or assigned adapter from“My Phone”function button of a value-added unit; it is to send a call request by the software phone and then passing the request to CMS via Internet in the step 701. Subsequently, in the steps 702, it is transmitting the request by the CMS to the predetermined or assigned adapter, and the adapter receives and detects the call request information; then authenticating the request with the built-in white lists which is checking usufruct of the built-in white lists by the adapter in the step 703. Next, it is to confirm the usufruct and then feedback a dialing signal from PSTN in the step 704. Next, in the step 705, dialing a callee phone number by the user is executed after user hearing the dial signal response from PSTN. In the step 706, it is transmitting the callee phone number by the adapter to PSTN, and then passing the calling message to the callee. Finally, in the step 707, it is completed for communicating between the callee and the user from software phone via Internet.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

We claim:

1. A method to make a fixed line of telephone network virtually portable, calling from fixed line to software phone comprising:
receiving call request with ringing signal by an adapter from PSTN;
re-sending a ringing signal from said adapter for said call request to a telephone connected to said adapter, and re-sending said call request to a center management system via the Internet followed by sending said call request to a software phone from said center management system;
receiving an answer signal by said adapter from said telephone or said software phone;
transferring the call with said ringing signal to said telephone or said software phone; and
communicating between a remote terminal of PSTN and said telephone or said software phone via Internet.

2. The method as set forth in claim 1, wherein said sending ringing signal to a telephone and re-sending the said call request to a software phone may be achieved synchronously.

3. The method as set forth in claim 1, wherein while one of said telephone and said software phone is selected to answer, the other will stop said ringing signal.

4. The method as set forth in claim 1, wherein said adapter comprises the Internet interface, a phone interface and a phone-line interface.

5. The method as set forth in claim 1, wherein said adapter comprises voice engine, a voice processing unit, an encryption unit.

6. The method as set forth in claim 1, wherein said software phone comprises voice engine, a voice processing unit, an encryption unit, value-added unit and contact lists.

7. The method as set forth in claim 1, wherein said center management system comprises Back-end Database Management and Online Network Management.

8. The method as set forth in claim 1, wherein said software phone is embedded in a portable device.

9. The method as set forth in claim 8, wherein said portable device comprises a personal computer, notebook (NB), personal digital assistant (PDA) or mobile phone.

10. A method to make a fixed line of telephone network virtually portable, subscribers can hear the dialing tone of said fixed line remotely via Internet and make calls thereafter, by integrating a phone adapter terminal, comprising:
sending a call request from a software phone by clicking either one of contacts from contact list or a function button,;
sending said call request to a center management system via the Internet;
transmitting said call request by said center management system to an adapter;
judging by said adapter whether to send a ringing signal to a telephone connected to said adapter or sending said call request to said fixed line, and feedback said dialing signal from PSTN, followed by dialing a callee phone number;
transmitting said callee phone number to said PSTN; and
communicating between said software phone and said telephone or said callee phone.

11. The method as set forth in claim 10, wherein sending said ringing signal to a telephone connected to said adapter, or feedback said dialing signal from PSTN is judged by said adapter.

12. The method as set forth in claim 10, wherein said sending a call request from a software phone comprises said user utilizes said software phone to select a callee from a common contact lists or a function button.

13. The method as set forth in claim 10, wherein said dialing a callee phone number is executed after said user hearing said dial signal from PSTN.

14. The method as set forth in claim 10, wherein said adapter comprises the Internet interface, a phone interface and a phone-line interface.

15. The method as set forth in claim 10, wherein said adapter comprises voice engine, a voice processing unit, an encryption unit.

16. The method as set forth in claim 10, wherein said software phone comprises voice engine, a voice processing unit, an encryption unit, value-added unit and contact lists.

17. The method as set forth in claim 10, wherein said center management system comprises Back-end Database Management and Online Network Management.

18. The method as set forth in claim 10, wherein said software phone is embedded in a portable device.

19. The method as set forth in claim 18, wherein said portable device comprise a personal computer, notebook (NB), personal digital assistant (PDA) or mobile phone

20. A method to make a fixed line of telephone network virtually portable, subscribers can hear the dialing tone of said fixed line remotely via Internet and make calls thereafter, with utilizing predetermined phone adapter terminal, comprising:
selecting a predetermined adapter and sending a call request from a software phone;
sending said call request to a center management system from said software phone by clicking either one of contacts from contact list or a function button via the Internet;
transmitting said call request by said center management system to said predetermined adapter;
authenticating the request with the built-in white lists by said predetermined adapter;
feedback said dial signal from PSTN;
dialing a callee phone number;
transmitting said callee phone number to said PSTN; and
communicating between said software phone and said callee phone.

21. The method as set forth in claim 20, wherein said sending a call request from a software phone comprises a user utilizes said software phone to select said predetermined adapter from a function button.

22. The method as set forth in claim 20, wherein said dialing a callee phone number is executed after said user hearing said dial signal from said PSTN.

23. The method as set forth in claim 20, wherein said predetermined adapter comprises the Internet interface, a phone interface and a phone-line interface.

24. The method as set forth in claim 20, wherein said predetermined adapter comprises voice engine, a voice processing unit, an encryption unit.

25. The method as set forth in claim 20, wherein said software phone comprises voice engine, a voice processing unit, an encryption unit, value-added unit and contact lists.

26. The method as set forth in claim 20, wherein said center management system comprises Back-end Database Management and Online Network Management.

27. The method as set forth in claim 20, wherein said software phone is embedded in a portable device.

28. The method as set forth in claim 27, wherein said portable device comprise a personal computer, notebook (NB), personal digital assistant (PDA) or mobile phone.
